(19) United States
(12) Patent Application Publication
(10) Pub. No.: US 2026/0317152 A1
(43) Pub. Date: Oct. 15, 2026

(54) BEVERAGE DISPENSING MACHINE WITH CUP DISPENSER

(71) Applicant: Marmon Foodservice Technologies, Inc., Osseo, MN (US)

(72) Inventors: Zachary Dresser, Batavia, IL (US); David K. Njaastad, Palatine, IL (US); Daniel Muskin-Pierret, Oak Park, IL (US); Michael A. Graef, Aurora, IL (US); Kessler Kerr, Carol Stream, IL (US)

(73) Assignee: Marmon Foodservice Technologies, Inc., Osseo, MN (US)

(21) Appl. No.: 19/643,370

(22) Filed: Apr. 9, 2026

Related U.S. Application Data
(60) Provisional application No. 63/787,695, filed on Apr. 11, 2025.

(51) Int. Cl. B67D 1/08; B65G 59/10

(52) U.S. Cl. CPC B67D 1/0894; B65G 59/108; B67D 1/0888; B65G 2201/0235; B65G 2203/0233; B65G 2203/042

(57) ABSTRACT

An automated beverage dispensing system receives a stack of cups at a dispensing assembly with a selective release device. A cup sensor produces a signal indicative of the absence of a cup in a cup holder positioned below the first selective release device. A controller is configured to receive an instruction to dispense a cup, obtain a signal indicative of the absence of a cup in the cup holder from the cup sensor, and then to operate the first selective release device through a cycle of a dispense operation. The controller is configured to receive a signal from a dispense sensor to determine when the first selective release device has operated through the cycle of the dispense operation. The controller is further configured to evaluate if the dispense was successful by analyzing the signal from the cup sensor to confirm a cup is present in the cup holder.

### CROSS-REFERENCE TO RELATED APPLICATION

The present application claims priority of U.S. Provisional Patent Application No. 63/787,695, filed on Apr. 11, 2025, the entire contents of which is hereby incorporated by reference.

### BACKGROUND

The present disclosure relates to beverage dispensing systems. More particularly, the present disclosure relates to automated beverage dispensing systems for automatically selecting and dispensing a cup.

Automated beverage dispensing systems are known in the fields of fast and quick service restaurants. Automated beverage dispensing systems automate, or partially automate, the act of filling cups with beverages to fulfill customer orders.

Examples of automated beverage dispensing systems are disclosed in the following patent references, which are hereby each incorporated by reference herein in their entireties:

U.S. Patent Nos. 3,279,652, “Cup Dispenser having a Plurality of Simultaneously Acting Circumposed Oscillating Cup Ejectors”; 4,418,837, “Automatic Cup Dispensing Apparatus”; 4,426,017, “Apparatus for Dispensing Containers from a Stack of Nested Containers”; and 5,518,149, “Cup Dispenser for Vending Machines” all disclose examples of cup dispensing devices.

U.S. Patent Nos. 9,944,472, “Beverage Dispensing Apparatus” and 11,208,316, “Semi-Automated Beverage Dispensing Machines and Methods” disclose linear configurations for transport of cups for loading, filling, and/or staging by a beverage machine.

U.S. Patent No. 10,689,240, “Automated Beverage Dispensing Machines” and 12,252,390, “Beverage Dispensing Machine with Cup Dispenser” disclose carousel-style configurations for transport of cups for loading, filling, and/or staging by a beverage machine.

U.S. Patent Nos. 7,669,732, “Cup Lid Dispenser”; 8,225,960, “Ice Dispensing System and Method”; 9,204,734, “Cup Storage System”; 9,656,849, “Modular Valve array Having a Single Dispense Point”; 10,515,327, “Beverage Dispensing Validation Method and System”; 11,158,151, “Systems and Methods for Nesting Cups from a Dispenser”; and U.S. Patent Application Publication No. 2022/0106181, “Beverage Dispensing Apparatus” all disclose other features which may be incorporated into examples of beverage dispensing machine as disclosed in further detail herein.

### BRIEF DISCLOSURE

An automated beverage dispensing system includes a conveyance system having a plurality of cup holders and configured to move the plurality of cup holders sequentially about the conveyance system. The automated beverage dispensing system further includes a cup dispensing system configured to receive a first stack of cups at a first dispensing assembly. The first dispensing assembly includes a first selective release device. The conveyance system is operable to sequentially position a cup holder of the plurality of cup holders below the first selective release device. The first selective release device includes a dispense sensor. A cup sensor is arranged relative to the conveyance system and the first selective release device. The cup sensor produces a signal indicative of the absence of a cup in the cup holder positioned below the first selective release device. A controller is configured to receive an instruction to dispense a cup, obtain a signal indicative of the absence of a cup in the cup holder from the first cup sensor, and then to operate the first selective release device through a cycle of a dispense operation. The controller is configured to receive a signal from the dispense sensor to determine when the first selective release device has operated through the cycle of the dispense operation. The controller is further configured to evaluate if the dispense was successful by analyzing the signal from the first cup sensor to confirm a cup is present in the cup holder.

In other examples, the controller may be further configured to advance the plurality of cup holders if the signal from the first cup sensor confirms the cup is present in the cup holder, and the controller may be configured to operate the selective release device through a second cycle of the dispense operation if the signal from the first cup sensor indicates the absence of a cup in the cup holder. The controller may be further configured to produce an indication of cup dispensing system malfunction upon the first cup sensor indicating the absence of a cup in the cup holder after the selective release device is operated through the second cycle of the dispense operation. The controller may be further configured to advance the plurality of cup holders after the second cycle of the dispense operation when the first cup sensor confirms the cup is present in the cup holder. The automated beverage dispensing system may further include a stack sensor arranged within the first dispensing assembly at a location above the first selective release device. The stack sensor may be configured to provide a signal to the controller indicative of the presence or absence of cups above the first selective release device. The stack sensor may be an optical sensor or an ultrasonic sensor. The controller may be configured to obtain a signal indicative of the presence of cups above the first selective release device before operating the first selective release device through the cycle of a dispense operation.

The cup dispensing system may be configured to receive a second stack of cups at a second dispensing assembly. The second dispensing assembly may include a second selective release device. The conveyance system may be operable to sequentially position a cup holder of the plurality of cup holders below the second selective release device. The cup sensor may be a first cup sensor and a second cup sensor may be arranged relative to the conveyance system and the second selective release device. The selective release device may include a plurality of cam assemblies. Each cam assembly of the plurality may include a cam body, a cam extending about the cam body, the cam having a cam edge, a leading cam surface and a trailing cam surface, a gear about the cam body, and a cup support flap connected to the cam body and extending radially away from an axis of the cam body. The first dispensing assembly may include a motor and a drive gear, and a belt may operatively extend between the drive gear and the gear about the cam body of each of the cam assemblies. Movement of the belt by the drive gear may simultaneously move each of the cam assemblies. The dispense sensor may be configured to determine when the drive gear has advanced a full revolution in the cycle of the dispense operation. The automated beverage dispensing system may further include a drive gear assembly having the drive gear. The drive gear assembly may further include a drive gear housing having a window therethrough. The dispense sensor may be configured to emit and/or receive energization through the window to provide the signal indicative that the first dispensing assembly has operated through the cycle of the dispense operation. The automated beverage dispensing system may further include a stack sensor arranged within the selective release device at a location above the first selective release device. The stack sensor may be configured to provide a signal to the controller indicative of the presence or absence of cups above the first selective release device. The cup sensor, the stack sensor, and the drive gear sensor may each be one of an optical sensor or an ultrasonic sensor.

A selective release device for dispensing a cup includes a frame defining an aperture configured to receive a stack of cups, a motor, a drive gear connected to the motor, a dispense sensor arranged to produce a signal indicative that the drive gear has rotated a complete revolution, a stack sensor arranged on the frame, and a controller configured to operate the motor in response to an instruction to dispense a cup. The controller is configured to receive and analyze a signal from the stack sensor to determine if the stack of cups is within the selective release device. The controller is configured to receive and analyze a signal from a cup sensor located at a cup loading location below the selective release device to determine if an associated cup holder at the cup loading location is empty. The controller is configured to operate the motor to complete a revolution of the drive gear based upon a signal from the dispense sensor.

In other examples, the selective release device may further include a cam assembly having a gear and a belt that engages the drive gear and the gear of the cam assembly. The belt may transfer rotation of the drive gear to rotation of the cam assembly. The selective release device may further include a plurality of cam assemblies. The plurality of cam assemblies may include the cam assembly, and the plurality of cam assemblies may be connected to the drive gear by the belt such that the plurality of cam assemblies simultaneously rotate with the drive gear. The selective release device may further include a drive gear housing connected to the drive gear. The drive gear housing may define a window therethrough. The dispense sensor may be arranged with a first portion of the dispense sensor external to the drive gear housing and a second portion of the drive gear sensor arranged interior of the drive gear housing. The dispense sensor may be an optical sensor with one of an emitter and a collector as the first portion exterior of the drive gear housing and the other of the emitter and the collector as the second portion interior of the drive gear housing. Passing of optical energy between the emitter and collector through the window of the drive gear housing may be indicative of a revolution of the drive gear by the motor.

A method of automated beverage dispensing includes receiving an instruction to dispense a cup from a selective release device. The method includes determining that cups for dispense are present at the selective release device by evaluating a signal from a stack sensor arranged at a position above the selective release device. The method includes determining that a cup holder of a conveyance system positioned below the selective release device is empty to receive a cup by evaluating a signal from a cup sensor fixed at a position below the selective release device. The method includes operating the selective release device through a cycle of a dispense operation. The method includes determining if a cup was dispensed by the selective release device by evaluating the signal from the cup sensor. If the cup is present, the method includes advancing the cup and cup holder of the conveyance system. If the cup is not present, the method includes operating the selective release device through a cycle of a dispense operation.

### BRIEF DESCRIPTION OF THE DRAWINGS

FIG. 1 is a perspective view of an example of a beverage dispensing machine.

FIG. 2 is a front view of the beverage dispensing machine.

FIG. 3 is a side view of the beverage dispensing machine.

FIG. 4 is a sectional view taken along line 4-4 of FIG. 2.

FIG. 5 is a detailed perspective view of the cup dispenser.

FIG. 6 is a sectional view taken along line 6-6 of FIG. 5.

FIG. 7 is a detailed view of an example of a selective release device.

FIG. 8 is an isolated view of the region about the drive gear in a selective release device.

FIG. 9 is a cross-sectional view of a portion of the selective release device.

FIG. 10 is a system diagram of an example of a beverage dispensing machine.

FIG. 11 is a flow chart depicting an example of a method of dispensing a cup.

FIG. 12 depicts a top perspective view of the drive gear assembly.

### DETAILED DISCLOSURE

Automated beverage dispensing machines, for example as disclosed in 12,252,390, “Beverage Dispensing Machine with Cup Dispenser” combine the automated dispensing of cups with the automated filling of those cups with a beverage to complete customer orders for specified beverage types and volumes. Sensing systems are disclosed herein to provide additional information regarding the operation and status of the beverage dispensing machine to provide for coordinated automated operation of such beverage dispensing machines.

Automated beverage dispensing machines typically operate to dispense cups to a single location. This is exemplarily shown in U.S. Patent No. 9,944,472, “Beverage Dispensing Apparatus” or U.S. Patent No. 10,689,240, “Automated Beverage Dispensing Machines.” Because the cups are delivered to a single point, the beverage dispensing machine can operate in a first-in-first-out (FIFO) manner to process received beverage orders. As each beverage in a customer order comes up, the machine operates to dispense the specified cup and then fill that cup with the specified beverage. However, more recent beverage dispensing machines are configured to dispense different cups to different locations, this is exemplarily disclosed in U.S. Patent No. 12,252,390. This opens the possibility to dispense multiple cups at the same time, however, increased automation requires improved arrangements of sensors for these coordinated operations.

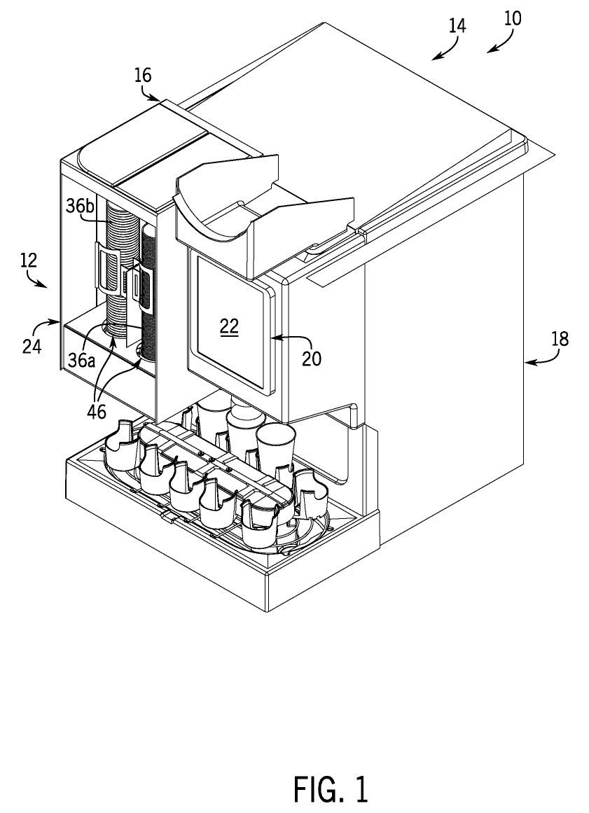

FIG. 1 is a perspective view of an example of a beverage dispensing machine 10 which is configured as a “crew serve” dispensing machine to automatedly or semi-automatedly dispense beverages consistent with a customer’s order. The beverage dispensing machine 10 is configured to provide automated cup selection, placement, ice dispensing, beverage dispensing, and staging of customer-ordered beverages, for example in a fast or quick service restaurant setting. Automation of crew-served beverage fulfillment process as provided with the features of the disclosure herein can improve the speed of service and order completion accuracy.

The beverage dispensing machine 10 is defined by a front 12, a back 14, and sides 16, 18. To facilitate operation in a restaurant configuration, the beverage dispensing machine 10 is both observable and configurable from the front. That is, the user interface 22, which may include a graphical display 20, the cup dispenser 24, and the cup carousel 26 are positioned at the front 12 of the beverage dispensing machine 10. As will be described in further detail herein, the beverage dispensing machine further includes an ice dispensing chute 30 and a beverage dispensing nozzle 34.

The cup carousel 26 includes a plurality of cup holders 38 which are configured to receive a cup 36 therein. The cup holders 38 thus define the positions of any cups relative to the cup carousel 26. The cup carousel 26 may further include a conveyor belt 40 to which the cup holders 38 are secured. A shelf 42, for example with a drip tray 44 defined therein underlies the cup holders 38 and the cup carousel 26. The shelf 42 and drip tray 44 serve to catch spilled beverage, ice, or debris so as not to interfere with the operation of the cup carousel 26 and the beverage dispensing machine 10. Operation of a motor (not depicted), exemplarily a servo motor, rotates the conveyor belt 40, along with the cup holders 38 secured thereto about an exterior of the cup carousel 26. The motor rotates the conveyor belt 40 to position the plurality of cup holders 38 at a plurality of successive indexed locations about the cup carousel 26.

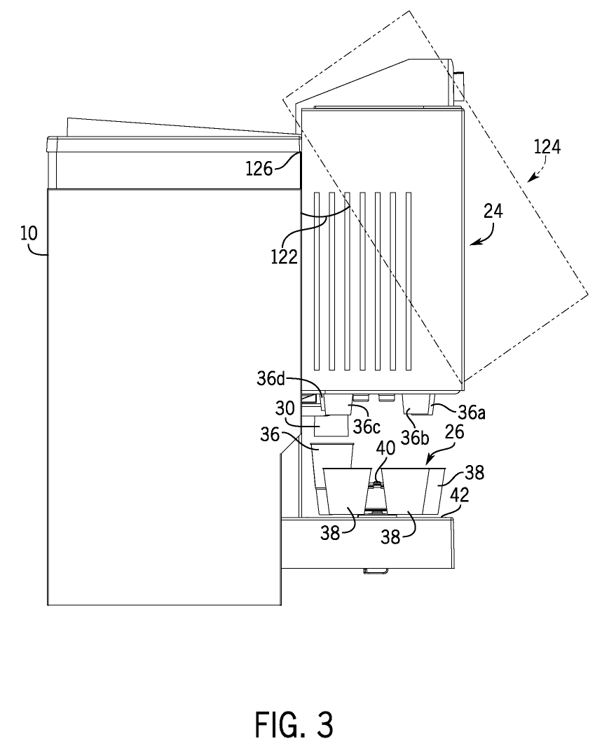

As will be explained in further detail herein, the carousel 26 has cup holders 38 at each of a plurality of carousel positions. The carousel 26 moves the cups holders 38 at these associated carousel positions through a plurality of indexed locations, each of which coincide with a function of the beverage dispensing machine. While provided in more detail with respect to FIG. 3, these indexed locations are exemplarily represented as locations 48a-48j. In brief description, indexed locations 48a-48d coincide with the cup dispenser 24, indexed location 48e coincides with the ice dispensing chute 30, indexed location 48f coincides with the nozzle 34, and indexed locations 48g-48j are staging locations for cups 36 filled with a dispensed beverage.

The cup dispenser 24 is arranged to dispense cups of one or more different sizes to different indexed locations within the automated beverage dispenser. The automated beverage dispenser may include a carousel that defines a plurality carousel positions which are moved to align with the series of indexed locations about the carousel path and each associated with a function of the beverage dispenser. The cup dispenser dispenses cups of different sizes into different indexed locations. The automated beverage dispenser may further operate to maintain a record of cups dispensed into cup holders 38 at particular positions about the carousel.

The cup dispenser 24 is configured to hold a plurality of stacks of cups 36 in which the beverages are to be dispensed. Each stack of cups is supported by and selectively released from an associated selective release device 46. In the example shown, the cup dispenser 24 includes four stacks 36a-36d of cups, each of which has an associated selective release device 46. It will be recognized that more or fewer stacks of cups may be provided while remaining within the scope of the present disclosure. Each of the stacks 36a-36d of cups may exemplarily be a different size, configured to hold a different volume of beverage. In other examples, the two or more of selective release devices 46 may be dimensioned and/or configured to hold and dispense cups of the same size, holding the same volume of beverage. The stacks 36a-36d of cups may be arranged with one or more stacks positioned behind, or towards the back 14 of the beverage dispensing machine 10 from other stacks. Alternatively, the stacks 36a-36d may be arranged with one or more stacks positioned towards the front 12 of the beverage dispensing machine or towards the side 16, 18 of the beverage dispensing machine. That is, each of the stacks 36a-36d occupies a separate fixed location relative to the rest of the beverage dispensing machine. The cup dispenser is arranged with selective release devices 46 to dispense cups from each of the stacks 36a-36d to different indexed locations 48a-48d about the carousel 26 within the automated beverage dispenser.

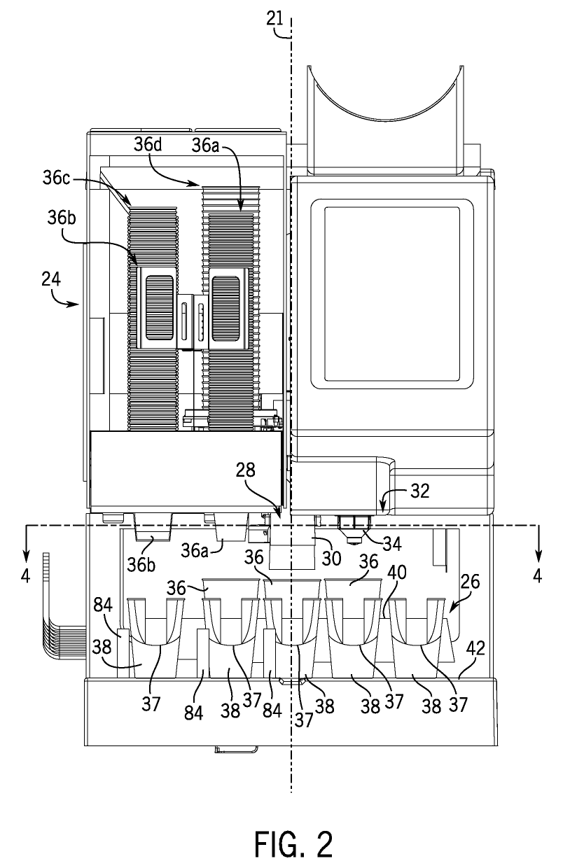

FIG. 2 is a front view of the beverage dispensing machine 10. Representative cup holders 38 at indexed locations 48a, 48b, and 48h-48j are visible from the front, with indexed locations 48c-48g set behind and visible in other views. FIG. 2 further depicts the ice dispensing chute 30, to which an ice dispenser 28 is connected for the dispense of ice into a cup 36 located at indexed location 48e. While not specifically depicted, the ice dispenser 28 exemplarily includes an ice bin associated with a cold plate, and may further include an auger or agitator which is operated to dispense a portion of the ice from the ice bin out through the ice dispensing chute 30. Further details of examples of these components may be found in US2025/0243047, “Carbonator and Cold-Plate System” which is incorporated by reference herein in its entirety. Nozzle 34 is further connected to a beverage dispensing system 32 for the dispense of an ordered beverage into a cup 36 located at indexed location 48f. While not specifically depicted, the beverage dispensing system further includes a plurality of fluid control valves which are operated to control the flow of pre-mixed beverages or beverage constituents. Fluid control valves may be operated to selectively dispense concentrated flavoring and a diluent fluid (e.g. still or carbonated water) from the nozzle 34 according to a drink order from a customer.

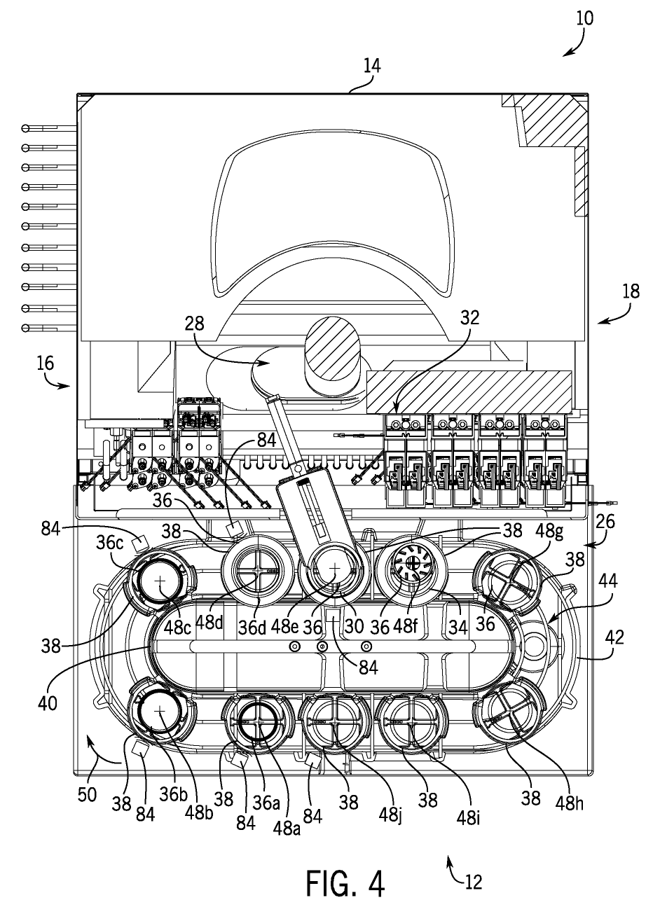

FIGS. 3 and 4 further depict the cup carousel 26. FIG. 3 is a side view of the beverage dispensing machine 10 and FIG. 4 is a sectional view of the beverage dispensing machine 10 taken along line 4-4 of FIG. 2. FIG. 4 depicts the cup carousel 26 which exemplarily includes ten cup holders 38. The cup carousel 26 operates to move the cup holders 38 through a sequence of indexed locations 48a-48j. The plurality of indexed locations 48a-48j around the carousel 26 thus defines an endless circuit of sequential indexed locations 48a-48j through which the cup holders 38 are moved with the cup holder 38 at indexed location 48j advancing to indexed location 48a. The cup holders 38 may be secured to the conveyor belt 40 with a dovetail connection, while other types of releasable connections may also be used. The beverage dispensing machine 10 is for example calibrated such that the carousel position of each of the cup holders is known. The conveyor belt 40 may be a silicone or rubber belt or may be formed of a plurality of articulated sections. In examples, flexibility or articulation in the conveyor belt 40 may provide a degree of lateral flexibility which facilitates conformity of the conveyor belt about the gears at either end of the cup carousel 26.

Indexed locations 48a-48d respectively coincide with the stacks 36a-36d of cups and the associated cup droppers 46 and therefore represent a plurality of cup loading locations. That is, a cup 36 dispensed from stack 36a of cups by the associated cup dropper 46 will drop into cup holder 38 positioned at indexed location 48a. A cup 36 dispensed from stack 36b of cups by the associated cup dropper 46 will drop into cup holder 38 positioned at indexed location 48b. A cup 36 dispensed from stack 36c of cups by the associated cup dropper 46 will drop into cup holder 38 positioned at indexed location 48c. A cup 36 dispensed from stack 36d of cups by the associated cup dropper 46 will drop into cup holder 38 positioned at indexed location 48d. Indexed location 48e coincides with the ice dispensing chute 30 of the ice dispenser 28. Ice dispensed through the ice dispensing chute 30 will fall into a cup positioned at indexed location 48e. Indexed location 48f coincides with the nozzle 34 of the beverage dispenser. A beverage dispensed through the nozzle 34 will fall into a cup positioned at indexed location 48f. Indexed locations 48g-48j respectively represent a plurality of staging locations of the plurality of indexed locations.

FIGS. 2 and 4 also show cup sensors 84. Cup sensors 84 are arranged at fixed locations relative to one or more indexed locations 48 and project a signal from which a determination can be made if a cup 36 is present in the cup holder 38 at an associated indexed location. In the example shown in FIGS. 2 and 4, the cup sensors 84 are arranged relative to indexed locations 48a, 48b, 48c, 48d, 48f, and 48j. However, it will be recognized that cup sensors 84 may be arranged relative to other indexed locations as well. The cup holders 38 exemplarily have a wall 37 defining a perimeter of the cup holder 38. The wall varies in height, with the wall 37 being lower to the interior and exterior sides from the conveyor belt 40 and higher at the lateral sides. This forms an aperture through which the cup sensor 84 can project energy towards the cup. In an example, the cup sensor 84 is an ultrasonic sensor, however, it will be recognized that other types of sensors including, but not limited to, light sensors. In other examples, an RFID tag or a sensible element e.g. metal foil may be embedded into the cups themselves, and the cup sensor may be an RF sensor or a magnetic sensor, respectively to sense the embedded component. Other examples of sensors will be recognized based upon these examples and considered to be within the scope of the present disclosure. As will be described in further detail herein, cup sensors 84 operate to provide a signal that is indicative of the presence (or absence) of a cup 36 in a cup holder 38 at an associated indexed location 48.

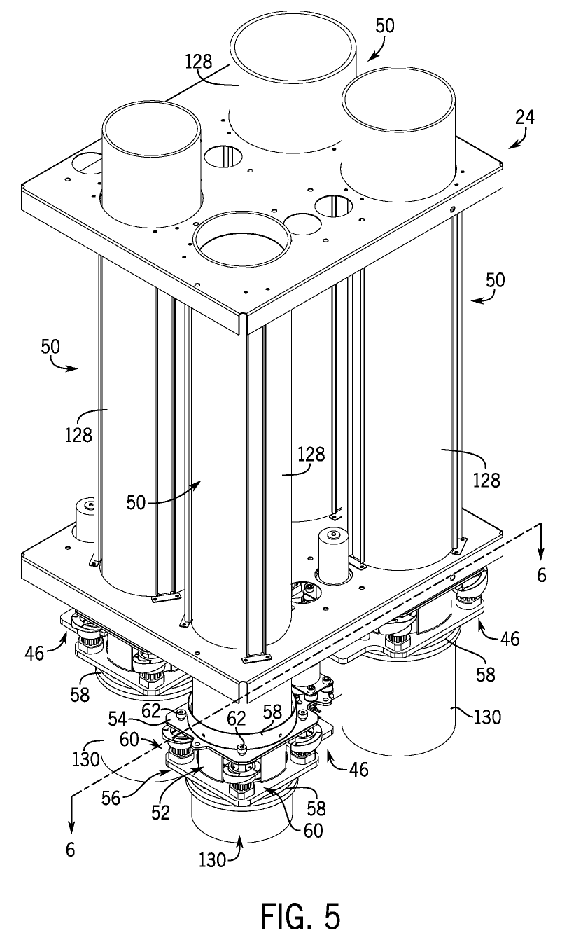

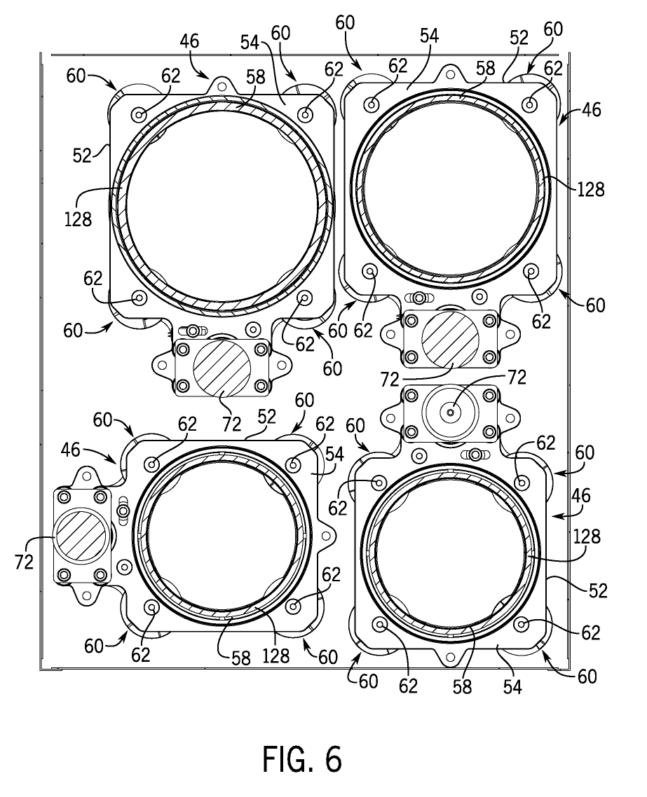

FIG. 5 is a detailed perspective view of the cup dispenser 24. FIG. 6 is a sectional view taken along line 6-6 of FIG. 5. The cup dispenser 24 includes a plurality of cup dispensing assemblies 50. Each cup dispensing assembly 50 is exemplarily configured for a specific size of cup. It will be recognized that a cup dispensing assembly 50 may be operable to dispense cups within a range of sizes, although in examples provided herein disclose features which may adapt a cup dispensing assembly 50 for optimal dispensing of a particularly sized cup for which the dispensing assembly 50 is designed. Each dispensing assembly 50 includes a selective release device 46. The selective release device 46 may exemplarily be a cup dropper, and the selective release device 46 is adapted to singulate and dispense individual cups as instructed by the system. The selective release device 46 is also configured to receive a stack of cups from which the selective release device 46 subsequently dispenses cups.

Each selective release device 46 exemplarily includes a frame 52 having an upper frame 54 and a lower frame 56. The upper frame 54 and the lower frame 56 each include an annular flange 58, respective annular flanges 58 extend away from the upper frame 54 or the lower frame 56. The annular flanges 58 may define a space for the stack of cups through the selective release device 46. The annular flanges 58 further function to respectively connect a support chimney 128 and a dispense chimney 130 to the frame 52. A plurality of cam assemblies 60 are rotatably positioned between the upper frame 54 and the lower frame 56. The cam assemblies 60 rotate about axles 62 secured between the upper frame 54 and the lower frame 56. The cam assemblies 60 extend partially interior of the annular flange 58. The annular flange 58 is dimensioned to receive a stack of cups with a predetermined outer diameter therethrough while the cam assemblies 60 engage a lip of the cups as described herein.

A stack of cups 36 may be loaded into a dispensing assembly 50 from the bottom past the selective release device 46. Because the stack of cups extends above the selective release device 46, a support chimney 128 that extends upwards from the frame 52 helps to maintain the stack of cups in alignment with the selective release device 46. Additionally, it has been found that the operation of the selective release device 46 imparts an oscillating motion on the stack of cups. This oscillating motion may move cups of the stack of cups out of axial alignment with one another. If the stack of cups is out of axial alignment, the operation and function of the selective release device may be impaired. The support chimney 128 counteracts this motion, keeping the stack of cups upright within the support chimney 128, this may maintain the weight of the stack of cups in axial alignment with the selective release device 46, improving the singulation and dispense of an individual cup upon operation of the beverage dispensing machine 10.

The dispensing assemblies 50 may also include dispense chimneys 130. The dispense chimneys 130 are connected to the annular flange 58 secured to the lower frame 56. As previously noted, the beverage dispensing machine 10 is configured to dispense beverages into a plurality of sizes of cups all dispensed from the cup dispenser 24. Improvements to the consistency of the dispense of multiple cup sizes into the same cup holders 38 may be achieved with modifications to the cup dispensing assemblies 50 dependent upon the size of cup for which the cup dispensing assembly 50 is configured. As described above, the selective release device 46 engages the lip of a cup to be dispensed. The selective release device 46 may therefore be positioned at a vertical distance above the cup carousel 26 and the cup holders 38 such that the bottoms of each of the cups to be dispensed are the same height from the bottoms of the respective cup holders 38 into which the cups will be dispensed. This has been found to provide a consistent interaction between the cup and the cup holder 38 into which it is dispensed, independent of the actual size of the cups dispensed. Therefore, as shown in FIG. 5, the vertical position of the selective release device 46 may be defined dependent upon the size of cup to be dispensed from an individual cup dispensing assembly 50. Additionally, with one or more of the selective release devices 46 positioned at different vertical positions, in some examples this may enable closer spacing of the selective release devices 46 as demonstrated by center point to center point distances between the selective release devices 46. This may result in a reduction in the footprint area of the cup dispenser 24.

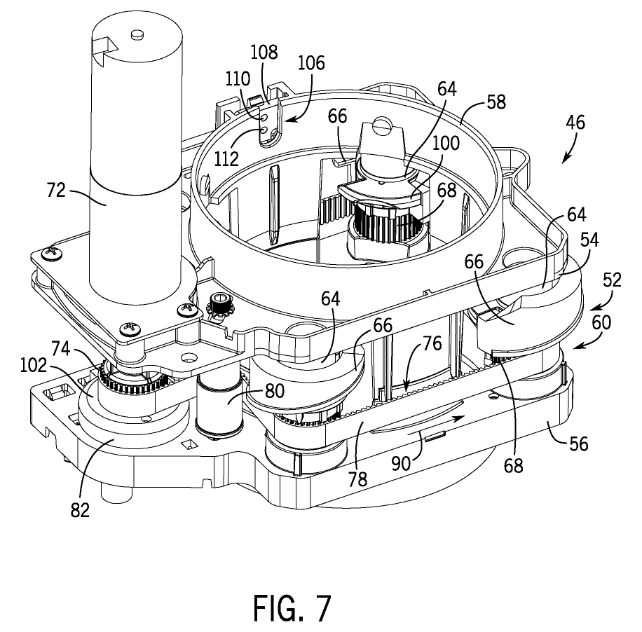

FIG. 7 is a detailed view of an example of a selective release device 46. Other examples of a selective release device will be recognized by a person of ordinary skill in the art, for example, as disclosed by U.S. Patent Nos. 9,944,472 and 10,689,240, already incorporated by reference above. The selective release device 46 exemplarily shown in FIG. 7 includes a plurality of cam assemblies 60, which operate to engage a lip of a cup and to singulate the cup from the stack of cups and to dispense the cup from the selective release device 46. The cam assembly 60 includes a cam assembly body 64. The cam assembly body 64 includes a cam 66 and a pulley gear 68. The cam assembly 60 further includes a cup support flap 100. An electric motor 72 provides motive power to the selective release devices 46. The electric motor 72 is exemplarily controlled by a controller of the beverage dispensing machine 10, and receives and operates according to one or more electrical signals upon which the motor 72 operates to advance the cam assemblies 60 as described herein to carry out a dispense of a selected cup. The electric motor 72 is connected to a drive gear 74. A belt 78 wraps around the drive gear 74 and the pulley gears 68 of each of the cam assemblies 60 of the selective release device 46. One or more rollers 80 may engage the belt 78 to facilitate a change of direction of the belt 78 towards the cam assemblies 60. The belt 78 operates to distribute the motive power from the electric motor 72 to all of the cam assemblies 60 simultaneously. The belt 78 is exemplarily constructed of a rubber, synthetic rubber, or other elastomeric material and may include internally facing teeth 76 that mesh with teeth of the respective drive gear 74 and the pulley gears 68. The interconnection of the cam assemblies 60 by the belt 78 and the teeth 76 of the belt 78 engaging the pulley gears 68 helps to evenly and simultaneously rotate the cam assemblies 60.

The belt 78 exemplarily rotates in the direction of arrow 90, and imparts a similar direction of rotation on each of the cam assemblies 60. As the cam assemblies 60 rotate, the cams 66 engage a cup to be dispensed above the lip of that cup and between respective lips of that cup and the subsequent cup in a stack of cups within the dispensing assembly 50. As the cam assemblies 60 continue to rotate, the cam 66 further engages a bottom of the lip of the subsequent cup while an opposite side of the cam 66 engages the top of the lip of the cup to be dispensed. As the cam assembly 60 rotates, the distance between the upper and lower surfaces of the cam 66 increases, increasing the distance between the lip of the cup to be dispensed and the lip of the subsequent cup in the stack of cups within the dispensing assembly 50. Engagement of the cam 66 between the lips of the cups forces the cups apart, providing a singulation of the cup to be dispensed from the subsequent cup and the rest of the cups in the stack of cups.

Completion of a revolution of the cam assembly 60 separates the cup 36 from the stack of cups, and the cup 36 is able to fall therefrom by the force of gravity into the cup holder 38 positioned a loading location 48 associated with the selective release device 46. It will be recognized that the dispensing assemblies 50 as shown and described may include a selective release device 46 which includes one or more of the cam assemblies 60 as shown and described. In the example shown in the Figures, the selective release devices 46 each include four cam assemblies 60 which synchronously operate in the manner described above due to the common operative engagement with the belt 78 driven by the motor 72.

As previously noted, the implementation of beverage dispense automation requires improved arrangements of sensors and feedback operations to coordinate the automated dispense of cups by a selective release device. As disclosed herein, three sensors are arranged within the dispensing assembly 50 and/or at the associated indexed location 48 to provide information before, during, and after each cycle of a dispense operation by a selective release device. Specifically, as described herein a stack sensor 108 operates for evaluation if the selective release device has a cup to dispense, a dispense sensor 88 operates for evaluation that the selective release device has operated through a cycle of a dispense operation, and a cup sensor 84 operates for evaluation at the cup holder 38 if a cup has been dispensed. The coordinated analysis of the signals from these sensors enables the automated beverage dispensing system to monitor and evaluate the operation of the cup dispenser 24 before, during, and after the operation of a selective release device to dispense a cup.

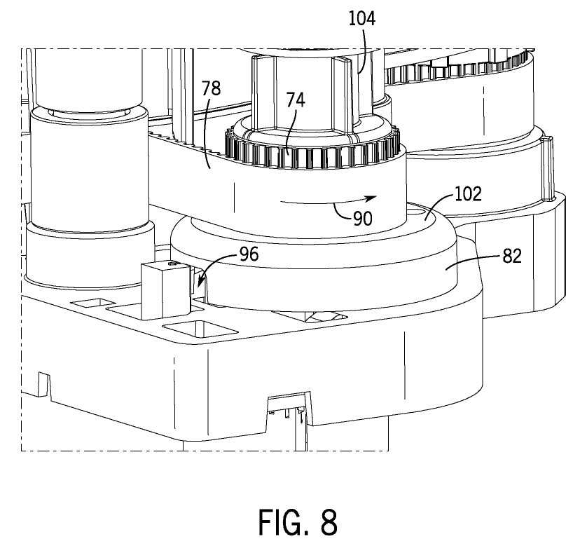

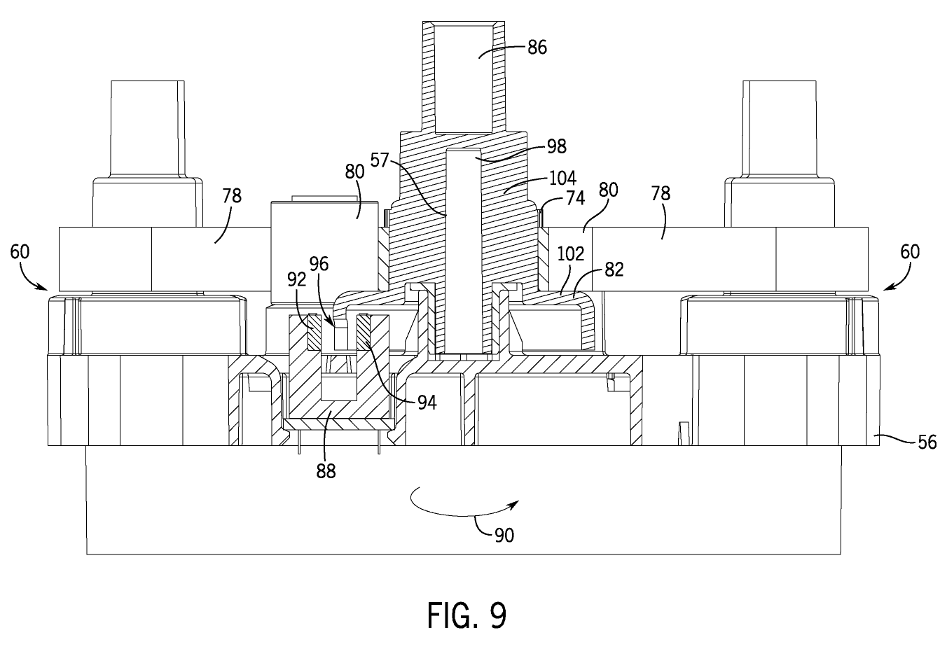

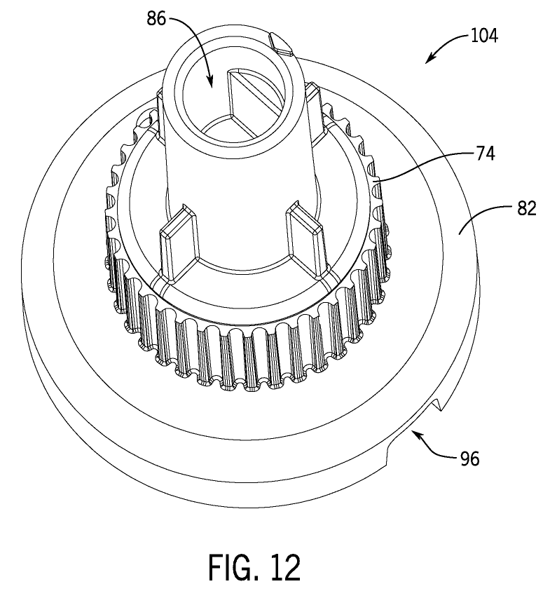

FIG. 8 is an isolated perspective view of the drive gear assembly 104 portion of the selective release device 46 shown in FIG. 7. FIG. 9 is a partial cross-sectional view of the selective release device taken along line 9-9 of FIG. 7. FIG. 12 provides an additional top perspective view of the drive gear assembly 104. It will be recognized that the drive gear assembly 104 is exemplarily a unitary piece, for example a molded component. The drive gear assembly 104 includes the drive gear 74 which transfers motive energy from the motor 72 to the belt 78. The drive gear assembly 104 also includes a drive gear housing 82 extending below the drive gear 74. The drive gear housing 82 includes a shoulder 102. The drive gear assembly 104 further defines a drive gear spindle 98 that is axially aligned with the drive gear assembly 104. The drive gear spindle 98 is received on a bearing surface 57 extending up from the lower frame 56. The drive gear assembly 104 spins axially about the spindle – bearing surface interface. The drive gear assembly 104 further defines a drive coupling 86 to which the motor 72 (FIG. 7) is connected. The drive coupling 86 may include a keyed or exemplarily “D” shaped slot to receive a mating portion a shaft of the motor 72. Operation of the motor 72 as described above rotates the entirety of the drive gear assembly 104, including the spindle 98, housing 82, and drive gear 74. The drive gear housing 82 further includes a window 96 therethrough.

A dispense sensor 88, which is exemplarily implemented in this example as a drive gear sensor is arranged with components as described herein positioned interior to the housing 82 and exterior to the housing 82. In an example, the drive gear sensor is an optical sensor with an emitter 92 arranged exterior of the housing 82 and a collector 94 arranged interior of the housing 82. The emitter 92 and collector 94 operate to respectively send and receive energization which may be electromagnetic energy, including but not limited to visible, infra-red, or ultraviolet light or larger wavelengths. In other examples, the emitter 92 and collector 94 may be ultrasonic. It will be recognized that positions of the emitter and collector may be reversed than that as described above. In a still further example, both of the emitter 92 and the collector 94 are arranged to a single side of the housing 82, while a detectable component (e.g. a reflective or contrasting target) is positioned to the side of the housing 82 opposite the combined emitter and collector. As previously noted, the drive gear housing 82 rotates with the gear 74, the window 96 comes into alignment with the emitter 92 and collector 94 of the sensor 88 upon each revolution of the drive gear 74 and the housing 82. The sensor 88, which is exemplarily an optical sensor, produces a signal indicative of an occurrence of this alignment and provides such signal to the controller as will be described herein. From this signal, the controller determines when the motor 72 has operated through a complete cycle of the dispense operation, in this example to make one complete rotation of the drive gear 74 and the housing 82. As described above, through the belt 78 each revolution of the drive gear 74 effects a complete revolution of the gears 68 of the respective cam assemblies 60.

As shown in FIG. 7, the flange 58, and more specifically the upper flange, further includes a window 106, and a stack sensor 108 is located adjacent the window 106. The stack sensor 108 is exemplarily an ultrasound sensor or an optical sensor, although other types of sensors will be recognized from these examples and are considered to be within the scope of the present disclosure. An optical sensor is exemplarily depicted with an optical emitter 110 and an optical collector 112. The stack sensor 108 emits energy into the interior of the selective release device in the region occupied by a stack of cups (not depicted) held by the selective release device for dispense. The stack sensor 108 is arranged to provide an output signal to the controller as described herein in which the output signal is indicative if there is a cup of the stack adjacent to the stack sensor 108 or if the stack of cups is depleted so as to be out of cups or nearly out of cups, e.g. a cup may be currently engaged with the cam assemblies 60 and/or the cup support flap 100 of the cam assemblies 60.

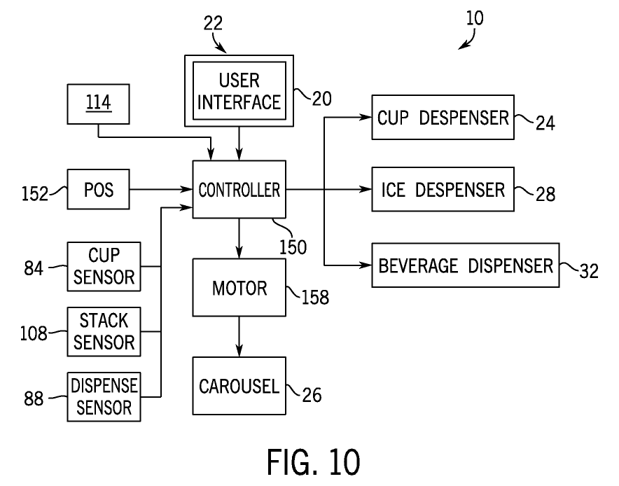

FIG. 10 is a system diagram of a beverage dispensing machine 10 as has been described herein. The beverage dispensing machine 10 includes a controller 150 which receives inputs from components depicted in FIG. 13 and as previously described above. In response to the inputs, the controller 150 produces outputs and control signals to the components depicted therein such as to carry out the functions of the beverage dispensing machine 10 as described herein. The controller 150 is exemplarily a single board computer (SBC) which includes a microprocessor and associated computing components for e.g. power management, communication, and/or memory. In examples, the controller 150 includes one or more processors which may be any suitable hardware processor or combination of processors, such as a central processing unit (CPU), a graphics processing unit (GPUT), an accelerated processing unit (APUT) a microcontroller, an application specific integrated circuit (ASIC), a field-programmable gate array (FPGA), etc. In examples, communicatively connected may mean wired or wireless communication connections. These may include any suitable hardware, firmware, and/or software for communicating information over a communication network or directly between hardware components of the system. The controller 150 executes computer readable code stored in a non-transient computer readable medium, causing the controller 150 to carry out the functions as described herein. The controller is connected to a computer readable medium 114, which is exemplarily computer memory upon which the software or firmware in the form of computer-executable codes is stored, the execution of such code by the controller 150 causes the controller 150 to send and receive signals to carry out the functions as described herein. Memory can include any suitable storage device or devices that can be used to store instructions, values, etc., that can be used, for example, by the processor to generate data, to receive data, to analyze data, to present content using the display, or to communicate between components. Memory can include any suitable volatile memory, non-volatile memory, storage, or any suitable combination thereof, including but not limited to random access memory (RAM), read-only memory (ROM), electronically-erasable programmable read-only memory (EEPROM), one or more flash drives, one or more hard disks, one or more solid state drives, one or more optical drives, etc. Memory can have encoded thereon a computer program that when executed by the controller, the controller carries out the processing of input and outputs as described above to carry out the described functionalities, including but not limited to carrying out the above functionality using one or more state machine implementations.

The controller 150 is configured to receive user inputs, including, but not limited to various orders of beverages to be dispensed. An order of a beverage to be dispensed exemplarily includes both a beverage size (e.g. volume) and a type (e.g. premixed beverage or selection of flavoring and diluent). The beverage dispensing machine 10 may operate to receive an order input through a user interface 22 presented on a graphical display 20. The computer 150 may be communicatively connected to the graphical display 20 to provide the graphical display 20 with instructions to operate to visually present the user interface 22 thereon. The graphical display 20 may further be a touch-sensitive graphical display operable to receive one or more user inputs of the beverage order and communicate those user inputs to the controller 150. In a still further example, the controller 150 is communicatively connected to a point of sale (POS) system 152 into which customer orders are received and processed for fulfillment. A restaurant may include communication kiosks operable by either a customer or by a restaurant employee to enter the customer order into the POS system. In still further examples, the POS system may operate to receive customer orders placed through an online order system. While examples of such communication is provided in the present disclosure, including, but not limited to that provided in US 10,689,240 and U.S. Patent Application Publication No. 2020/0273283, it will be recognized that other manners of communication of customer beverage orders into the beverage dispensing machine may be used. Once such orders are received by the POS system 152, the orders are communicated to the controller 150 and the beverage dispensing machine 10 may operate as disclosed to automatedly fulfill the received customer orders.

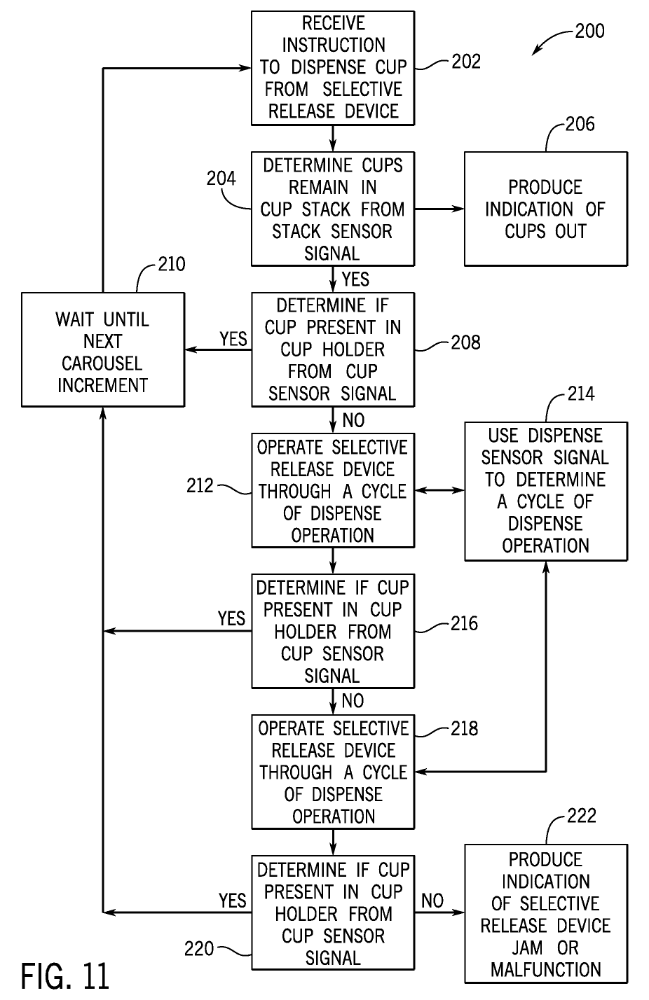

FIG. 11 is a flow chart depicting an example of a method 200 of dispensing a cup from a selective release device 46. At 202 the controller 150 receives an instruction to dispense a cup from a selective release device 46 of the plurality of selective release devices described above. This instruction is exemplarily a part of a customer order of a beverage which includes the cup size dispensed by this selective release device 46 of the plurality of selective release devices. At 204, the controller makes a determination if cups remain in the stack of cups 36 held by that selective release device 46. This determination is based upon receiving the signal from the stack sensor 108 as described above and analyzing the signal to determine if the signal indicates that cups remain in the monitored stack. If no cups are detected in the signal, then at 206, the controller operates to produce an indication that the selective release device 46 is out of cups. This indication may exemplarily be presented on the user interface 22 presented on the graphical display 20. In other examples, the cup dispenser 24 may include one or more indicator LED lights which may be illuminated to provide this indication.

If it is determined at 204 that the selective release device 46 has cups in the associated stack, then at 208, the controller 150 makes a further determination if there is already a cup present in the cup holder 38 currently at the indexed location associated with the selective release device. This determination is made by analyzing the signal provided to the controller by the cup sensor 84, which may exemplarily be an ultrasonic sensor as described above. If a cup is already present, the selective release device 46 cannot be operated to dispense an additional cup into this already occupied cup holder 38. At 210 the controller 150 waits until the carousel has advanced by another increment, and the method 200 is repeated to attempt to drop a cup into the new cup holder 38.

If it is determined at 208 that the cup holder 38 is empty and therefore capable of receiving a cup from the selective release device 46, then at 212, the controller operates the selective release device 46 to operate through a cycle of the dispense operation, that is through a complete operation designed to result in the dispense of a cup. In the example of the selective release device 46 shown, for example, in FIG. 7, this includes operating the motor 72 to advance the drive gear 74 one full revolution. As previously described, the drive gear 74 is connected to the cam assemblies 60 of the selective release device 46 and advancement of the drive gear 74 by one full revolution, also advances the cam assemblies 60 by one full revolution. A single full revolution, as described above, separates a lowermost cup from the associated stack of cups so that the separated cup can fall by gravity into the cup holder 38. It will be recognized that other selective release devices will include other operations or sequences of operations to carry out a complete operation designed to result in the dispense of a cup. As described above, the dispense sensor 88 operates to evaluate the operation of the selective release device 46 to determine if the operation has been performed. At 214, the controller uses the signal from the dispense sensor 88 to determine if a single cycle of the dispense operation has been performed. In the specific example as shown above, the dispense sensor 88 is a drive gear sensor and produces as signal from which the controller 150 can determine when the drive gear 74 has made a full revolution. After one full revolution, operation of the motor is stopped to stop advancement of the drive gear 74 and cam assemblies 60.

After a cycle of the dispense operation has been completed, the controller 150 then performs a check at 216 to determine if a cup is now present in the cup holder 38. This determination is made by analyzing the signal from the cup sensor 84 as described above. The controller 150 in this step determines if the attempted cup dispense is a success and the cup was dispensed into the cup holder 38. If the dispense was a success, the method waits at 210 until the carousel is advanced to the next increment. However, if no cup is detected in the cup holder 38 based upon an analysis of the signal from the cup sensor 84, then the controller at 218 again operates the selective release device through a cycle of a dispense operation, which in the specific example shown includes the motor 72 to advancing the drive gear 74 one full revolution.

As described above, the signal from the dispense sensor 88 at 214 is used to determine when the selective release device has operated through a cycle of the dispense operation, exemplarily that the motor 72 has advanced the drive gear 74 by one full revolution, after which the controller 150 operates the motor 72 to stop.

Again at 220 the controller operates to determine if a cup 36 is now present in the cup holder 38. This determination is made by analyzing the signal from the cup sensor 84 as described above. The controller 150 in this step determines if the attempted cup dispense is a success and the cup was dispensed into the cup holder 38. If this dispense attempt was a success, the method waits at 210 until the carousel is advanced to the next increment. However, if no cup is detected in the cup holder 38 based upon an analysis of the signal from the cup sensor 84, then at 222 the controller produces an indication that the selective release device is either jammed or otherwise malfunctioning. This indication may exemplarily be presented in the graphical user interface 22 presented on the graphical display 20, or may be the illumination of one or more LED lights associated with the cup dispenser. The retry logic implemented by the controller 150 as described above, accounts for situations where a cup may not have been fully singulated or released during the first revolution attempt. For example, a cup lip may have been partially engaged by the cam assemblies 60 but not fully separated from the stack during the first revolution. While a second cycle is described before the the warning indication is produced, it will be recognized that a second cycle may balance efficiency in reattempted dispense versus malfunction identification, however, the number of cycles to be performed before the warning indication is produced may be other numbers and may further be a user-configurable number while remaining within the scope of the present disclosure.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification. It is recognized that the examples provided herein as well as in the references incorporated by reference are examples of the disclosure and that still further combinations of the features of these individual disclosures are recognized to be made and are considered to be within the scope of the present disclosure.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An automated beverage dispensing system comprising:
a conveyance system comprising a plurality of cup holders and configured to move the plurality of cup holders sequentially about the conveyance system;
a cup dispensing system configured to receive a first stack of cups at a first dispensing assembly, the first dispensing assembly comprising a first selective release device, the conveyance system operable to sequentially position a cup holder of the plurality of cup holders below the first selective release device, the first selective release device comprising a dispense sensor;
a cup sensor arranged relative to the conveyance system and the first selective release device, the cup sensor producing a signal indicative of the absence of a cup in the cup holder positioned below the first selective release device; and
a controller configured to receive an instruction to dispense a cup, obtain a signal indicative of an absence of a cup in the cup holder from the cup sensor, and then to operate the first selective release device through a cycle of a dispense operation, the controller configured to receive a signal from the dispense sensor to determine when the first selective release device has operated through the cycle of the dispense operation, the controller further configured to evaluate if the dispense was successful by analyzing the signal from the cup sensor to confirm a cup is present in the cup holder.

2. The automated beverage dispensing system of claim 1, wherein the controller is further configured to advance the plurality of cup holders if the signal from the cup sensor confirms the cup is present in the cup holder, and the controller is configured to operate the first selective release device through a second cycle of the dispense operation if the signal from the first cup sensor indicates the absence of a cup in the cup holder.

3. The automated beverage dispensing system of claim 2, wherein the controller is further configured to produce an indication of cup dispensing system malfunction upon the cup sensor indicating the absence of a cup in the cup holder after the first selective release device is operated through the second cycle of the dispense operation.

4. The automated beverage dispensing system of claim 2, wherein the controller is further configured to advance the plurality of cup holders after the second cycle of the dispense operation when the cup sensor confirms the cup is present in the cup holder.

5. The automated beverage dispensing system of claim 1, further comprising a stack sensor arranged within the first dispensing assembly at a location above the first selective release device, wherein the stack sensor is configured to provide a signal to the controller indicative of the presence or absence of cups above the first selective release device.

6. The automated beverage dispensing system of claim 5, wherein the stack sensor is an optical sensor or an ultrasonic sensor.

7. The automated beverage dispensing system of claim 5, wherein the controller is configured to obtain a signal indicative of the presence of cups above the first selective release device before operating the first selective release device through the cycle of a dispense operation.

8. The automated beverage dispensing system of claim 1, wherein the cup dispensing system is configured to receive a second stack of cups at a second dispensing assembly, the second dispensing assembly comprising a second selective release device, the conveyance system operable to sequentially position a cup holder of the plurality of cup holders below the second selective release device; and
wherein the cup sensor is a first cup sensor and further comprising a second cup sensor arranged relative to the conveyance system and the second selective release device.

9. The automated beverage dispensing system of claim 1, wherein the first selective release device comprises a plurality of cam assemblies, each cam assembly of the plurality comprising:
a cam body;
a cam extending about the cam body;
a gear about the cam body; and
a cup support flap connected to the cam body and extending radially away from an axis of the cam body.

10. The automated beverage dispensing system of claim 9, wherein first dispensing assembly comprises a motor and a drive gear, and further comprising a belt operatively extending between the drive gear and the gear about the cam body of each of the cam assemblies, wherein movement of the belt by the drive gear simultaneously moves each of the cam assemblies.

11. The automated beverage dispensing system of claim 10, wherein the dispense sensor is configured to determine when the drive gear has advanced a full revolution in the cycle of the dispense operation.

12. The automated beverage dispensing system of claim 11, further comprising a drive gear assembly comprising the drive gear, the drive gear assembly further comprising a drive gear housing having a window therethrough, wherein the dispense sensor is configured to emit and/or receive energization through the window to provide the signal indicative that the first dispensing assembly has operated through the cycle of the dispense operation.

13. The automated beverage dispensing system of claim 11, further comprising a stack sensor arranged within the first dispensing assembly at a location above the first selective release device, wherein the stack sensor is configured to provide a signal to the controller indicative of the presence or absence of cups above the first selective release device.

14. The automated beverage dispensing system of claim 13, wherein the cup sensor, the stack sensor, and the dispense sensor are each one of an optical sensor or an ultrasonic sensor.

15. A selective release device for dispensing a cup, the selective release device comprising:
a frame defining an aperture configured to receive a stack of cups;
a motor;
a drive gear connected to the motor;
a dispense sensor arranged to produce a signal indicative that the drive gear has rotated a complete revolution;
a stack sensor arranged on the frame; and
a controller configured to operate the motor in response to an instruction to dispense a cup, wherein the controller is configured to receive and analyze a signal from the stack sensor to determine if the stack of cups is within the selective release device, receive and analyze a signal from a cup sensor located at a cup loading location below the selective release device to determine if an associated cup holder at the cup loading location is empty, and the controller is configured to operate the motor to complete a revolution of the drive gear based upon a signal from the dispense sensor.

16. The selective release device of claim 15, further comprising:
a cam assembly comprising a gear; and
a belt that engages the drive gear and the gear of the cam assembly, wherein the belt transfers rotation of the drive gear to rotation of the cam assembly.

17. The selective release device of claim 16, further comprising a plurality of cam assemblies, the plurality of cam assemblies comprising the cam assembly, and wherein the plurality of cam assemblies are connected to the drive gear by the belt such that the plurality of cam assemblies simultaneously rotate with the drive gear.

18. The selective release device of claim 15, further comprising a drive gear housing connected to the drive gear, the drive gear housing defining a window therethrough, wherein the dispense sensor is arranged with a first portion of the dispense sensor external to the drive gear housing and a second portion of the dispense sensor arranged interior of the drive gear housing.

19. The selective release device of claim 18, wherein the dispense sensor is an optical sensor with one of an emitter and a collector as the first portion exterior of the drive gear housing and the other of the emitter and the collector as the second portion interior of the drive gear housing, wherein passing of optical energy between the emitter and collector through the window of the drive gear housing is indicative of a revolution of the drive gear by the motor.

20. A method of automated beverage dispensing comprising:
receiving an instruction to dispense a cup from a selective release device;
determining that cups for dispense are present at the selective release device by evaluating a signal from a stack sensor arranged at a position above the selective release device;
determining that a cup holder of a conveyance system positioned below the selective release device is empty to receive a cup by evaluating a signal from a cup sensor fixed at a position associated to the selective release device;
operating the selective release device through a cycle of a dispense operation;
determining if a cup was dispensed by the selective release device by evaluating the signal from the cup sensor:
wherein if the cup is present, advancing the cup and cup holder of the conveyance system; and
wherein if the cup is not present, operating the selective release device through a cycle of a dispense operation.
